(19) United States
(12) Patent Application Publication
(10) Pub. No.: US 2024/0317964 A1
(43) Pub. Date: Sep. 26, 2024

(54) FUMED ALUMINIUM OXIDE AS ANTI-SETTLING AGENT IN POLYMER-BASED THERMALLY CONDUCTIVE MIXTURES

(71) Applicant: Evonik Operations GmbH, Essen (DE)

(72) Inventors: Wojciech PISULA, Mainz (DE); Gerald WISSLER, Mainhausen (DE); Aziz MOUSSAOUI, Gelnhausen (DE); Mareike GIESSELER, Maintal (DE); Franz SCHMIDT, Groß-Gerau (DE); Michael HUTH, Maintal (DE); Patrick BECKER, Roßdorf (DE); Christoph TONTRUP, Alzenau (DE)

(73) Assignee: Evonik Operations GmbH, Essen (DE)

(21) Appl. No.: 18/613,656

(22) Filed: Mar. 22, 2024

(30) Foreign Application Priority Data
Mar. 22, 2023 (EP) 23163355.3

(51) Int. Cl. C08K 3/22; C08K 7/18; C08K 9/04; C09K 5/08

(52) U.S. Cl. CPC C08K 3/22; C08K 7/18; C08K 9/04; C09K 5/08; C08K 2003/2227; C08K 2201/001; C08K 2201/005; C08K 2201/006

(57) ABSTRACT

The present invention relates to a composition comprising at least one prepolymer, thermally conductive particles and particles of fumed aluminium oxide having a BET surface area of 15 m²/g to 200 m²/g. The invention further relates to a method for producing a heat-conducting composition comprising the step of adding fumed aluminium oxide having said BET surface area to the composition. The present invention also relates to the use of fumed aluminium oxide having a BET surface area of 15 m²/g to 200 m²/g to reduce sedimentation of thermally conductive particles in polymer compositions.

### TECHNICAL FIELD

The present invention relates to a composition comprising at least one prepolymer, thermally conductive particles and particles of fumed aluminium oxide having a BET surface area of 15 m²/g to 200 m²/g. The invention also relates to a method for producing a thermally conductive polymer composition comprising the step of adding fumed aluminium oxide having a BET surface area of 15 m²/g to 200 m²/g to the composition. The present invention additionally relates to the use of fumed aluminium oxide having a BET surface area of 15 m²/g to 200 m²/g for reducing the sedimentation of thermally conductive particles in polymer compositions.

### TECHNICAL BACKGROUND

Thermally conductive plastics are used in many technical fields in which efficient heat conduction is required. These include, in particular, cladding of electronic components and electrical insulators, which generate large amounts of heat in the smallest of spaces. In order to ensure the functional reliability and sufficient service life of these components, the heat generated must be efficiently dissipated. For optimal heat dissipation, composites and adhesives or fillers used in the construction of said claddings or components should also be thermally conductive. Such components are therefore often produced from plastics comprising one or more prepolymer(s), which are mixed with one another in the liquid or viscous state together with various additives and fillers, before they are cured to give the finished polymeric material.

It is known from the prior art that thermal conductivity increases with the proportion of thermally conductive fillers in the composition. In the case of low- to medium-filled and readily free-flowing formulations, sedimentation is particularly pronounced. This is due to the significantly different densities of the filler on the one hand and of the prepolymer on the other hand. For instance, aluminium oxide, which is known from the prior art for its thermal conductivity, has a density of 3.5 to 4 g/cm³, whereas the prepolymers used to produce thermally conductive plastics, however, only have a density of about 0.8 g/cm³ to 2 g/cm³.

Sedimentation is undesirable, however, as it leads to uneven thermal conduction of the finished product, which may result in damage to the finished component during operation or in overall reduced efficiency of heat conduction. This in turn can impair the functional reliability and the service life of the entire technical system in which the component is installed.

The use of fumed silica in thermally conductive compositions to reduce sedimentation behaviour is known from the prior art. However, this additive has the disadvantage of adversely affecting the thermal conductivity of the finished product. Other anti-settling substances are known, for example, from CN 104 693 806 A. Although this document discloses a series of anti-settling substances, it neither provides an indication of particularly advantageous properties of individual anti-settling substances, nor of specific features of these anti-settling substances that would be particularly relevant for the intended use.

A further disadvantage of anti-settling substances known in the prior art is that these have negative effects on the rheology of the composition prior to curing. The addition of known anti-settling substances may increase the viscosity at high shear rates to such an extent that the meterability is impaired. Poor meterability results in greater complexity in the production of the desired end product, which makes the production of the respective product less resource- and cost-efficient. In addition, high viscosity impairs the flow behaviour when applying the composition to a surface or when injecting the composition into a mould or gap, so that a uniform distribution of the composition prior to curing cannot be guaranteed. An uneven distribution of the composition leads to insufficient or even complete lack of heat dissipation.

WO 2009/032212 discloses a composition having high proportions of fumed aluminium oxide (at least 5% by weight to 80% by weight). The cited document relates specifically to achieving high filler loadings; the disclosure does not relate to the properties of the composition with respect to sedimentation.

Therefore, there is a need for an efficient and specific anti-settling substance. Such a substance is efficient, and accordingly more cost-effective and resource-sparing, if a strong effect can be achieved by adding a small amount of the additive. Such a substance is specific if it specifically reduces or completely prevents sedimentation without harming the processability, the meterability and the thermal conductivity of the formulation, compared to the use of anti-settling substances known in the prior art, such as fumed silica for example.

The object of the present invention, therefore, was to provide an anti-settling substance for thermally conductive compositions, which works both efficiently and specifically, whereby particularly in the case of low to moderate proportions of thermally conductive particles, the sedimentation of said particles should be reduced or completely prevented.

### SUMMARY

It has been found, surprisingly, that this object can be achieved by incorporating fumed aluminium oxide having a BET surface area of 15 m²/g to 200 m²/g and having a proportion of less than 5% by weight, based on the composition, into a composition.

The present invention therefore relates to a composition comprising thermally conductive particles, characterized in that the composition additionally comprises fumed aluminium oxide having a BET surface area of 15 m²/g to 200 m²/g and having a proportion of less than 5% by weight, based on the composition.

The present invention further relates to a method for producing a thermally conductive polymer composition, characterized in that the method comprises a step of adding less than 5% by weight, based on the composition, fumed aluminium oxide having a BET surface area of 15 m²/g to 200 m²/g to the composition.

The invention also relates to the use of fumed aluminium oxide having a BET surface area of 15 m²/g to 200 m²/g for reducing sedimentation of thermally conductive particles in polymer compositions.

### DETAILED DESCRIPTION

Unless otherwise stated, the numerical parameters and ranges given in the following description and the appended claims are approximate values. Accordingly, unless explicitly stated otherwise, all numbers expressing values, ranges, amounts or percentages may be read as if they were prefixed by the word “approximately”, even if the term is not explicitly prefixed. Notwithstanding the fact that the numerical ranges and parameters describing the broad scope of the invention are approximate values, the numerical values in the specific examples are stated as accurately as possible. All numerical values contain errors, however, that inevitably result from the standard deviation of the measurement thereof.

Each numerical range listed here includes all the subranges contained therein. For example, a range of “1 to 10” is intended to include all subranges between and including the specified minimum value of 1 and the specified maximum value of 10, i.e. all subranges which start at a minimum value equal to or greater than 1 and end at a maximum value equal to or less than 10, e.g. 1 to 6.3 or 5.5 to 10 or 2.7 to 6.1. In the context of the present disclosure, all end points of ranges and/or numbers within these ranges may be combined.

The term “comprising” herein is to be understood to be open-ended and not excluding the presence of additional elements, materials, constituents or process steps etc. that are not described or mentioned. The terms “including”, “containing”, “formed from” and similar terms are to be understood as synonymous with “comprising”. The term “consisting of” used here excludes the presence of unspecified elements, ingredients, process steps etc. Although the disclosure has been described in terms of “comprising”, “consisting of” or “consisting essentially of” also fall within the scope of the present disclosure.

In the context of this disclosure, the phrases “consisting essentially of” and “essentially formed from” a material signify that the corresponding component is formed predominantly from the named material and other materials are present in small amounts at most. The other materials are generally not added intentionally but originate, for example, from impurities, if present, or incomplete separation. The other materials are typically present in such small amounts that they do not noticeably affect the properties of the component in question. For example, “consisting essentially of” and “formed essentially from” herein may signify that the respective component, for example the respective aggregates, particles or prepolymers, are formed from or consist of the named material to an extent of 95% by weight or more, preferably 99% by weight or more, more preferably 99.5% by weight or more, particularly preferably 99.9% by weight or more.

The singular form of “one” and “the” includes the plural form, unless the context does not clearly stipulate otherwise.

The amounts disclosed herein are specified in % by weight with respect to the constituents of the composition according to the invention and refer to the total weight of the composition, unless stated otherwise.

The term “polymer” used herein is to be understood to include both homopolymers, i.e. polymers that are derived from one type of monomer, and copolymers, i.e. those polymers that are derived from two or more different types of monomers. In this context, the term “prepolymer” refers to a polymer that may be crosslinked and thus cured, for example chemically, thermally or by means of irradiation, optionally using a catalyst and/or a crosslinker. In the context of the present invention, it is preferable that the prepolymer is liquid or free-flowing. This means that free-flowing prepolymers may also comprise medium to highly viscous polymers having a viscosity of 10 mPas to 100 000 mPas (at 25° C. measured at a shear rate of 10 s⁻¹).

The dimensions listed herein of the specific surface area or BET surface area refer to the mass-based specific surface area, and is specified in g/m² unless otherwise stated. All specific surface areas disclosed herein were determined by BET analytical methods. The technical details of this analytical method are known to those skilled in the art, inter alia, from DIN ISO 9277.

The thixotropic index mentioned herein is given by the formula TI=η(Ylow)/η(Yhigh), where η(Ylow) is the viscosity at a low shear rate and η(Yhigh) is the viscosity at a high shear rate. All thixotropy data herein are based on a low shear rate of 1 s⁻¹ and a high shear rate of 100 s⁻¹. The respective viscosities are viscosities of the respective compositions comprising at least one prepolymer, thermally conductive particles and fumed aluminium oxide having a BET surface area of 15 m²/g to 200 m²/g. The viscosities are measured as described in the examples.

In the context of the present invention, a thermally conductive substance or material, in particular thermally conductive particles, can be a substance or a material which has a thermal conductivity of at least 1.0 W/mK, preferably at least 1.5 W/mK, more preferably at least 1.8 W/mK. Methods of measuring the thermal conductivity of a substance are known to those skilled in the art. Thermal conductivity can be determined, inter alia, by heat flow calorimetry.

The particles and aggregates described herein may also be described by the D50, D10 and/or D90 particle size. The D50 particle size, which is also referred to as the median value, gives that particle size of the volume-based particle size distribution, below or above which 50% of all particles occur. The D10 particle size accordingly gives that particle size of the volume-based particle size distribution below which 10% of all particles lie. The D90 particle size accordingly gives that particle size of the volume-based particle size distribution below which 90% of all particles lie. The particle and aggregate sizes stated herein, unless stated otherwise, refer to the D50 values of the particle size and aggregate size distributions respectively, which were determined by laser diffraction according to ISO 22412:2017.

The present composition according to the invention comprises at least one prepolymer. This can be a prepolymer selected from silicones, polyethers, polyepoxides, polyurethanes, polyacrylates, polymethacrylates, silane-modified polymers and combinations thereof. The at least one prepolymer is preferably selected from silicones. The at least one prepolymer may be modified, in particular terminally modified, i.e. in that the at least one prepolymer has a reactive functional group in at least one position, preferably at least two positions. This functional group can react either with a crosslinker or another functional group of the prepolymer. Depending on the chemistry of the crosslinking, this may require a catalyst or external supply of energy.

Accordingly, the composition may be cured by means of at least one crosslinker, at least one catalyst, heating and/or irradiation. The curing agent or method to be used in each case depends on the prepolymer selected, wherein two or more of the curing agents or methods cited above may be used simultaneously. For example, a silicone prepolymer may be terminally modified with vinyl groups, which react in the presence of a platinum catalyst at elevated temperature with a SiH-crosslinker, and thus cure the composition.

Accordingly, the total amount of the at least one prepolymer, depending on the prepolymer(s) used or the curing method used, consists of one or more components. For example, a prepolymer to be cured by means of a crosslinker and a catalyst consists of two components. The first component may comprise a portion of the prepolymer and the crosslinker dissolved or dispersed therein, whereas the second component may comprise another portion of the prepolymer and the catalyst dissolved or dispersed therein.

The at least one prepolymer may be present in the composition according to the invention in a total amount of 1% by weight to 75% by weight, preferably 5% by weight to 50% by weight.

A second constituent of the composition according to the invention are thermally conductive particles. These thermally conductive particles may be selected from graphene, quartz, aluminium nitride, boron nitride, silicon carbide, aluminium oxide having a BET surface area of 0.01 m²/g to 20 m²/g, and combinations thereof. It is particularly preferred that aluminium oxide having a BET surface area of 0.01 m²/g to 20 m²/g, particularly preferably the thermally conductive particles being selected from aluminium oxide having a BET surface area of 0.05 m²/g to 15 m²/g. This aluminium oxide fraction, if present, is to be distinguished from the fraction of the fumed aluminium oxide according to the invention which functions as anti-settling agent. If the thermally conductive particles are aluminium oxide particles, two different fractions of aluminium oxide are thus present in the composition. In particular, the fumed aluminium oxide and the aluminium oxide, if this is present as thermally conductive material in the composition, differ in their BET surface area. In addition, the two aluminium oxide fractions may differ in average particle size or the form of the particles.

The thermally conductive particles may be present preferably in the form of spherical particles. Due to their dense sphere packing, spherical particles are particularly suitable for application in thermally conductive plastics. These particles may have a size of 0.1 μm to 200 μm, preferably 0.5 μm to 150 μm. The thermally conductive particles particularly advantageously comprise at least a first and second fraction of thermally conductive particles, wherein the first fraction comprises thermally conductive particles of a D50 size which is at least by a factor of 5, preferably at least by a factor of 10, more preferably at least by a factor of 15 smaller than the D50 size of the particles of the fraction of the second thermally conductive particles. This ensures a particularly dense packing of the thermally conductive particles, which improves the thermal conductivity of the cured composition. To achieve a particularly dense packing, it is preferred if the first and the second fraction of thermally conductive particles are present in a ratio by amount of from 7 to 3 to 3 to 7, preferably in a ratio by amount from 6 to 4 to 4 to 6.

The thermally conductive particles may be present in the composition in a total amount of 30% by weight to 95% by weight, preferably 50% by weight to 95% by weight.

As already described, the aforementioned object can be achieved by the addition according to the invention of fumed aluminium oxide having a BET surface area of 15 m²/g to 200 m²/g and having a proportion of less than 5% by weight, based on the composition, to a composition.

The fumed aluminium oxide is preferably present in the form of aggregates. It is known to those skilled in the art that such aggregates are primary particles stored together which are held together by sintering. These primary particles should preferably be small in relation to the aggregates. The size of the primary particles from which the aggregates are formed is therefore preferably smaller than the size of the aggregates at least by a factor of 10, particularly preferably by a factor of 25. Moreover, it is preferable that the aggregates have an average size of 50 nm to 1 μm, preferably 100 to 800 nm. If the aggregates are too small, the viscosity at low shear rates is adversely affected. If however the aggregates are greater than 1 μm, the aggregates themselves may tend to sedimentation. The fumed aluminium oxide has a BET surface area of 15 m²/g to 200 m²/g, preferably of 25 m²/g to 200 m²/g.

The ratio between BET surface area and aggregate size of the fumed aluminium oxide can also be represented by the efficiency index. This value is a result of the product of the aggregate size and the BET surface area of the aggregates (dAgg×BET) and is specified in mm³/kg. For a particularly efficient inhibition of the sedimentation of the thermally conductive particles in the composition, the efficiency index of the fumed aluminium oxide may be preferably between 3 mm³/kg and 100 mm³/kg.

The fumed aluminium oxide according to the invention may also be hydrophobically modified. By means of hydrophobic modification, the compatibility of the anti-settling agent with the prepolymer matrix increases, and thus an improved incorporability and dispersibility can be achieved compared to unmodified fumed aluminium oxide. The fumed aluminium oxide may be modified, for example, with silicone oil, octamethylcyclotetrasiloxane, hexamethyldisilazane, dimethyldichlorosilane, or combinations thereof.

The fumed aluminium oxide may be present in the composition according to the invention in a total amount of 0.05% by weight to 5% by weight, based on the composition, preferably 0.1% by weight to 4% by weight, particularly preferably 0.3% to 3% by weight.

The composition according to the invention may be advantageously characterized by a thixotropic index TI of 6 to 80, preferably 10 to 50. Such a thixotropic index is favourable in that even small additions of the fumed aluminium oxide according to the invention can greatly increase the viscosity of the composition at low shear rates, which greatly reduces or ideally completely prevents sedimentation of the thermally conductive particles during storage of the composition. In addition, the viscosity however only increases a little at high shear rates which enables good meterability and processing of the composition.

In addition to those described above, the composition according to the invention may also comprise further constituents as additives. The additives used may be, for example, organic and inorganic pigments, dyes, pH regulators, fire retardants, susceptors, stabilizers, processing aids or mixtures and combinations of the same. Examples of pigments include titanium dioxide, ferrites, zirconium dioxide and carbon blacks. Suitable stabilizers are phenols, particularly sterically hindered phenols. One additive or a mixture of two or more additives may be present in the powder according to the invention. The appropriate additive is used in each case in an amount suitable for the desired purpose. Common use amounts are known to those skilled in the art. The total amount of additives, based on the total weight of the composition, may be, for example, up to 10% by weight, up to 6% by weight, up to 3% by weight, up to 2% by weight, up to 1% by weight, up to 0.5% by weight, up to 0.25% by weight, up to 0.2% by weight, up to 0.1% by weight, or up to 0.05% by weight. In a preferred practice of the present invention, the composition according to the invention comprises essentially no additives; i.e. additives are present, if at all, only as impurities in the composition. In a further preferred practice of the present invention, the composition according to the invention does not contain any additives.

The present invention further relates to a method for producing a thermally conductive composition, characterized in that the method comprises a step of adding less than 5% by weight, based on the composition, fumed aluminium oxide having a BET surface area of 15 m²/g to 200 m²/g to the composition.

The fumed aluminium oxide may be incorporated in the composition before, after or in parallel with the thermally conductive particles. Therefore, the method according to the invention may comprise a step of initially charging or adding the fumed aluminium oxide to the thermally conductive particles, wherein the fumed aluminium oxide is preferably mixed homogeneously with the thermally conductive particles. For this purpose, dry mixing processes known to those skilled in the art may be used. The fumed aluminium oxide and/or the thermally conductive particles can be incorporated using standard mixing techniques for (free-flowing) solids and liquid or viscous polymer materials, for example by compounding.

Depending on the prepolymer used, the composition according to the invention can be used for a multiplicity of technical applications. These may include, inter alia, adhesives, fillers, sealants and thermally conductive articles and components.

For this purpose, the composition according to the invention can be formed into articles or components by means of conventional techniques such as pressing, (injection) moulding or forming, optionally at elevated temperatures and/or elevated pressure, and cured at the same time. In an alternative practice, the composition according to the invention in the non-cured state can be applied to at least part of a surface of an article or component and then be subjected to a curing process as described above.

The following examples are intended to describe the composition according to the invention and the use thereof according to the invention, without limiting the invention to the examples.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding European application No. 23163355.3, filed Mar. 22, 2023, are incorporated by reference herein.

### Examples

### Preparation of the Formulation

### Composition 1 (Base Formulation) (Non-Inventive)

8.12% by weight silicone polymer VS 200 from Evonik
86% by weight spherical aluminium oxide particles BAK-40 (40 μm)/BAK-2 (2 μm) 60/40 from Bestry
3.52% by weight inhibitor mixture 1-ethynyl-1-cyclohexanol from Aldrich (as 2% mixture in silicone polymer VS 200)
0.6% by weight KAT 511 platinum catalyst from Evonik (as 10% mixture in silicone polymer VS 200)
1.76% by weight SiH crosslinker Crosslinker 100 from Momentive

### Composition 2 (Inventive)

6.12% by weight silicone polymer VS 200 from Evonik
86% by weight spherical aluminium oxide particles BAK-40 (40 μm)/BAK-2 (2 μm) 60/40 from Bestry
2% by weight aluminium oxide particles (AEROXIDE® Alu C 805 or Alu 45, Evonik Industries).
AEROXIDER Alu C 805 corresponds to a surface-modified fumed aluminium oxide described above, whereas AEROXIDE® Alu 45 is unmodified.
3.52% by weight inhibitor mixture 1-ethynyl-1-cyclohexanol from Aldrich (as 2% mixture in silicone polymer VS 200)
0.6% by weight KAT 511 platinum catalyst from Evonik (as 10% mixture in silicone polymer VS 200)
1.76% by weight SiH crosslinker Crosslinker 100 from Momentive

### Dry Mixing of Fillers

The fillers (BAK-40/BAK-2 60/40 or BAK-40/BAK-2 60/40+aluminium oxide particles) are mixed in advance using the dry mixing process in a Hauschild Speedmixer. The fillers are weighed into a Speedmixer beaker and homogenized for 4 minutes at 2000 min⁻¹, optionally in up to 5 stages due to heating.

### Preparation of the Compounds

Firstly, 6.12% by weight silicone polymer VS 200, 3.52% by weight inhibitor mixture 1-ethynyl-1-cyclohexanol and 0.6% by weight KAT 511 platinum catalyst are mixed in the Hauschild Speedmixer for 15 s at 2000 min⁻¹. Then the filler mixture from the dry-mixing process (BAK-40/BAK-2 60/40 or BAK-40/BAK-2 60/40+aluminium oxide particles) is dispersed 4× for 60 s each at 2000 min⁻¹. Subsequently, 1.76% by weight SiH crosslinker Crosslinker 100 is mixed therein 2× for 30 s each at 2000 min⁻¹.

### Preparation of the Test Specimens

The crosslinking of test specimens of the compounds having a thickness of 6 mm and a diameter of 55 mm is carried out in a hot press under a pressure of 100 bar and a temperature of 120° C. for 10 minutes. The test specimens are then post-crosslinked in an oven at 200° C. for 4 hours.

### Determination of the Thixotropic Index

Determination of the rheological properties of liquid silicone with aluminium oxide as filler. Viscosity [Pa*s] describes the property of a substance to flow under the influence of stress and to be irreversibly deformed. The shear rate results from the function of the speed [m/s] of the measuring cone and the gap [m] between the measuring cone and the plate.

The samples of filled liquid silicone must be stored in the measuring room for at least 4 hours prior to the viscosity measurement in order to reach ambient temperature. A Haake RheoStress 1 rheometer from Thermo Scientific is used with the RheoWin control program. The measurement is regulated by the speed, i.e. by the shear rate of 1 s⁻¹ to 100 s⁻¹. A cone with measuring geometry C20/2° Ti and the measuring plate attachment MPC 35 is used at a cone-plate gap distance of 0.105 mm.

### Thermal Conductivity Measurement

The thermal conductivity of the crosslinked test specimens was determined according to ASTM D7984 using a measurement technique based on the transient plane source method for determining thermal conductivity.

### Measurement of Aggregate Size

For measuring hydrophilic aggregates of, for example, AEROXIDE® Alu 45, a 1% by weight dispersion in water is prepared. 0.2 g of the hydrophilic material is initially charged in a 20 ml sonication vessel and 19.8 g of demineralized water is added thereto. A commercially available ultrasonic finger is used for the dispersion. The dispersing finger is dipped 1.5 cm into the dispersion. The sample is sonicated for five minutes at half power of the equipment.

For measuring hydrophobic aggregates of, for example, AEROXIDE® Alu C 805, a 1% by weight dispersion in ethanol is prepared. 0.2 g of the hydrophobic material is initially charged in a 20 ml sonication vessel. 20 g of ethanol are added thereto with 40 g of a high molecular weight wetting additive. A commercially available ultrasonic finger is used for the dispersion. The dispersing finger is dipped 1.5 cm into the dispersion. The sample is sonicated for five minutes at half power of the equipment.

Depending on the optical density, 500-2500 mg of the dispersion is placed in a cuvette and topped up to 2500 mg with the dispersion medium. This cuvette is then used to measure the size distribution. A dynamic light scattering device is used for the measurement in accordance with ISO 22412:2017.

| | Base formulation + | | | | | | | | | Visual |
|---|---|---|---|---|---|---|---|---|---|---|
| | additive | | | Efficiency | | | | | | observation |
| | Base formulation: | Aggregate | | index | | | | Thixotropic | | of |
| | 86% by weight | diameter | | (d_{agg} × | Viscosity | Viscosity | Viscosity | index | Thermal | sedimentation |
| | BAK-40/BAK-2 | (nm) of | BET | BET) in | (Pas) | (Pas) | (Pas) | η(1 s⁻¹)/ | conductivity | tendency, |
| | in 60/40 ratio | additive | (m²/g) | mm³/kg | at 1 s⁻¹ | at 10 s⁻¹ | at 100 s⁻¹ | η(100 s⁻¹) | (W/mK) | processability |
| Ref. | Base | — | — | — | 19.2 | 6.2 | 4.4 | 4.4 | 2.2 | Very rapid |
| | formulation | | | | | | | | | settling |
| Ref. | Base | — | — | — | 35.4 | 12.3 | 6.1 | 5.8 | 2.7 | Rapid settling |
| 2 | formulation + | | | | | | | | | |
| | 2% by | | | | | | | | | |
| | weight BAK- | | | | | | | | | |
| | 40/BAK-2 in | | | | | | | | | |
| | 60/40 ratio | | | | | | | | | |
| Ex. | Base | 170 | 100 | 17 | 516.2 | 62.7 | 12.9 | 40.0 (very | 2.5 | Very high |
| 1 | formulation + | | | | | | | high) | | efficiency |
| | 2% by | | | | | | | | | (strong |
| | weight | | | | | | | | | effect), no |
| | AEROXIDE ® | | | | | | | | | sedimentation, |
| | Alu C 805 | | | | | | | | | good |
| | | | | | | | | | | processability |
| Ex. | Base | 260 | 45 | 11.7 | 156.8 | 20.1 | 7.3 | 21.5 | 2.5 | Very high |
| 2 | formulation + | | | | | | | (high) | | efficiency |
| | 2% by | | | | | | | | | (strong |
| | weight | | | | | | | | | effect), no |
| | AEROXIDE ® | | | | | | | | | sedimentation, |
| | Alu 45 | | | | | | | | | good |
| | | | | | | | | | | processability |
| Ex. | Base | 226 | 15 | 3.4 | 63.6 | 13.5 | 6.1 | 10.4 | 2.5 | Moderate |
| 3 | formulation + | | | | | | | (medium) | | efficiency |
| | 2% by | | | | | | | | | against |
| | weight | | | | | | | | | sedimentation |
| | aluminium | | | | | | | | | |
| | oxide | | | | | | | | | |
| | particles | | | | | | | | | |
| | produced on | | | | | | | | | |
| | a metal | | | | | | | | | |
| | powder raw | | | | | | | | | |
| | material in a | | | | | | | | | |
| | hot flame | | | | | | | | | |
| Ref. | Base | 360 | 7.8 | 2.8 | 35.6 | 12.8 | 6.1 | 5.8 (low) | 2.5 | Low |
| 3 | formulation + | | | | | | | | | efficiency |
| | 2% by | | | | | | | | | against |
| | weight sub- | | | | | | | | | sedimentation |
| | micrometre | | | | | | | | | |
| | calcined | | | | | | | | | |
| | and ground | | | | | | | | | |
| | aluminium | | | | | | | | | |
| | oxide | | | | | | | | | |
| | particles | | | | | | | | | |
| Ref. | Base | 170 | 100 | 17 | 2314 | 308 | 32 | 72.3 (very | 2.8 | Very high |
| 4 | formulation + | | | | | | | high) | | efficiency |
| | 5% by | | | | | | | | | (strong |
| | weight | | | | | | | | | effect), no |
| | AEROXIDE ® | | | | | | | | | sedimentation, |
| | Alu C 805 | | | | | | | | | but no |
| | | | | | | | | | | processability |
| | | | | | | | | | | because of |
| | | | | | | | | | | excessive |
| | | | | | | | | | | viscosity at |
| | | | | | | | | | | 10 s⁻¹. |
| Ref. | Base | 260 | 45 | 11.7 | 796 | 120 | 1 | 796 (very | 3.2 | Very high |
| 5 | formulation + | | | | | | | high) | | efficiency |
| | 5% by | | | | | | | | | (strong |
| | weight | | | | | | | | | effect), no |
| | AEROXIDE ® | | | | | | | | | sedimentation, |
| | Alu 45 | | | | | | | | | but poor |
| | | | | | | | | | | processability |
| | | | | | | | | | | because of |
| | | | | | | | | | | excessive |
| | | | | | | | | | | viscosity at |
| | | | | | | | | | | 10 s⁻¹. |

Results

It can be seen from the table that products comprising fumed aluminium oxide having a BET surface area in the range according to the invention, despite a small use amount, possess a particularly high efficiency without having to accept losses in the thermal conductivity of the finished product. This is particularly the case if they are additionally hydrophobized.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Composition comprising at least one prepolymer and at least one fraction of thermally conductive particles, characterized in that the composition additionally comprises fumed aluminium oxide having a BET surface area of 15 m²/g to 200 m²/g (DIN ISO 9277) and having a proportion of less than 5% by weight, based on the composition.

2. Composition according to claim 1, characterized in that the fumed aluminium oxide has an aggregate size of 50 nm to 1 μm (laser diffraction according to ISO 22412:2017), preferably 100 nm to 800 nm.

3. Composition according to claim 1, characterized in that the fumed aluminium oxide has an efficiency index of 3 mm³/kg to 100 mm³/kg, wherein the efficiency index is the product of aggregate size and BET surface area.

4. Composition according to claim 1, characterized in that the composition comprises
1% by weight to 75% by weight, preferably 5% by weight to 50% by weight, of at least one prepolymer,
30% by weight to 95% by weight, preferably 50% by weight to 95% by weight, thermally conductive particles, and/or
0.05% by weight to 5% by weight, preferably 0.1% by weight to 4% by weight, fumed aluminium oxide.

5. Composition according to claim 1, characterized in that the prepolymer is selected from silicones, polyethers, polyepoxides, polyurethanes, poly(meth)acrylates, silane-modified polymers and combinations thereof, preferably selected from silicones.

6. Composition according to claim 1, characterized in that the thermally conductive particles are selected from graphene, quartz, aluminium nitride, boron nitride, silicon carbide, aluminium oxide having a BET surface area of 0.01 m²/g to 20 m²/g, and combinations thereof.

7. Composition according to claim 6, characterized in that the thermally conductive particles are selected from aluminium oxide having a BET surface area of 0.01 m²/g to 20 m²/g, preferably 0.05 m²/g to 15 m²/g.

8. Composition according to claim 1, characterized in that the thermally conductive particles are in the form of spherical particles.

9. Composition according to claim 8, characterized in that the spherical particles have a size of 0.1 μm to 200 μm, preferably 0.5 μm to 150 μm.

10. Composition according to claim 1, characterized in that the fumed aluminium oxide is hydrophobically modified.

11. Composition according to claim 10, characterized in that the fumed aluminium oxide is modified with silicone oil, octamethylcyclotetrasiloxane, hexamethyldisilazane, dimethyldichlorosilane, or combinations thereof.

12. Composition according to claim 1, characterized in that the thermally conductive particles comprise at least one first and one second fraction of thermally conductive particles, wherein the first fraction comprises particles of a D50 size which is at least by a factor of 5, preferably at least by a factor of 10, more preferably at least by a factor of 15 smaller than the D50 size of the particles of the second fraction.

13. Composition according to claim 1, characterized in that the composition is cured by means of at least one crosslinker, at least one catalyst, heating and/or irradiation.

14. Method for producing a thermally conductive polymer composition, characterized in that the method comprises a step of adding less than 5% by weight, based on the composition, fumed aluminium oxide having a BET surface area of 15 m²/g to 200 m²/g to the composition.

15. (canceled)
